(19) United States
(12) Patent Application Publication
(10) Pub. No.: US 2018/0287179 A1
(43) Pub. Date: Oct. 4, 2018

(54) HEAT MANAGEMENT METHOD IN A HIGH-TEMPERATURE STEAM ELECTROLYSIS (SOEC), SOLID OXIDE FUEL CELL (SOFC) AND/OR REVERSIBLE HIGH-TEMPERATURE FUEL CELL (RSOC), AND HIGH-TEMPERATURE STEAM ELECTROLYSIS (SOEC), SOLID OXIDE FUEL CELL (SOFC) AND/OR REVERSIBLE HIGH-TEMPERATURE FUEL CELL (RSOC) ARRANGEMENT

(71) Applicant: SunFire GmbH, Dresden (DE)

(72) Inventors: Dietmar Rueger, Bannewitz (DE); Joerg Brabandt, Dresden (DE); Oliver Posdziech, Dresden (DE)

(21) Appl. No.: 15/565,222

(22) PCT Filed: Apr. 8, 2015
(86) PCT No.: PCT/DE2015/100149

§ 371 Date: Oct. 9, 2017

(51) Int. Cl. H01M 8/18; C25B 1/12; C25B 15/02; C25B 15/08; H01M 8/04007

(52) U.S. Cl. CPC H01M 8/186; C25B 1/12; H01M 8/04007; C25B 15/08; C25B 15/02

(57) ABSTRACT

A heat management method in a high-temperature steam electrolysis [SOEC] (FIG. 1), to solid oxide fuel cells [SOFCs] (FIG. 2) and/or to a reversible high-temperature fuel cell having the SOEC and SOFC modes of operation [rSOC] (FIG. 1/2). The steam required (1) is supplied from at least one external source and at least one offgas stream (4, 12, 12a) is cooled at least once (3, 11, 18, 35) downstream of the cell [SOEC, SOFC, rSOC] (5, 5a). The internal generation of steam required (1, 38) is effected by internal recuperative heating of externally supplied water (47, 48, 51). The energy from the at least one cooling operation (3, 11, 18, 35) of the at least one offgas stream to be cooled (4, 4a, 12, 12a, 17, 20, 34, 36) is used for this purpose, and at the same time the external steam supply (1, 38) is reduced or shut down. Also a high-temperature steam electrolysis [SOEC] arrangement, solid oxide fuel cell [SOFC] arrangement and/or reversible high-temperature fuel cell arrangement with the SOEC and SOFC modes of operation [rSOC], each having an electrolysis/fuel cell (5, 5a), two gas supply conduits (8, 15), two gas outlet conduits (4, 12/12a), wherein at least one water evaporation arrangement (18, 35, 53), a steam generator and/or heat exchanger for steam generation is arranged in at least one gas outlet conduit (4, 12, 12a) in order to generate steam (1, 38) from water (47, 48, 51).

The present invention relates to a heat management method in a solid oxide electrolysis cell (SOEC), a solid oxide fuel cell (SOFC), and/or a reversible high temperature fuel cell having operating modes SOEC and SOFC [reversible oxide fuel cell, rSOC], wherein required steam is supplied from at least one external source and at least one exhaust gas stream is cooled at least once after the cell [SOEC, SOFC, rSOC].

The invention also relates to a high temperature steam electrolysis [SOEC], solid oxide fuel cell [SOFC] and/or reversible high temperature fuel cell [rSOC] arrangement.

In the prior art a high-temperature steam electrolysis (SOEC) is operated with steam, which is decomposed into hydrogen and oxygen with the aid of external electric energy. The advantage of the steam electrolysis is that, compared to conventional water electrolysis, it requires less electrical energy, since the energy expenditure for the evaporation of the water does not have to be applied by electroenergy in the electrolysis process.

The supply of an SOEC with steam is generally carried out from external sources, such as, for example, from cooling of the boiling water of synthesis processes, such as those in Fischer-Tropsch synthesis, methane synthesis or another hydrocarbon synthesis, or other exothermic processes.

However, due to different load states between steam generation and steam consumption in the electrolysis, an over supply or steam deficiency occurs in the electrolysis, which results from discontinuous synthesis processes, for example, depending on the availability of regeneratively generated electricity via solar energy or wind energy.

In order to operate a SOEC at atmospheric or elevated pressures, a corresponding pressure is required in the steam used. This means that the direct use of heat sources for producing the steam used at a temperature of <100° C. does not appear possible.

A reversible high-temperature fuel cell (rSOC) generates electric energy from hydrogen and air in fuel cell operation (SOFC operation—solid oxide fuel cell). In this respect, it has been recognized on the other hand that, after utilization of the exhaust gas heat from the fuel cell for the preheating of the hydrogen and the air, a high amount of heat remains in the exhaust gas stream which, if no external heating is carried out, is released unused to the atmosphere. In the electrolysis operation (SOEC operation) of the rSOC hydrogen and oxygen are produced from steam and electrical energy, it being recognized that even here that a relatively large amount of heat remains in the O₂—offgas stream after internal heat recovery, which is discharged unused to the environment.

The steam supply for the electrolysis operation of an SOEC, in particular rSOC, has hitherto occurred from external sources, for example by coupling the SOEC, in particular rSOC with exothermic synthesis processes. The hydrogen for the fuel cell operation of an SOFC, in particular the rSOC, comes either from external sources, is produced in the process itself by reforming hydrocarbons which in turn originate from external sources or can be generated in the electrolysis operation of the rSOC or a SOEC and stored in suitable storage, such as pressure accumulator or natural gas network, for the subsequent fuel cell operation.

A part of the problems in the prior art identified Applicant are essentially:

Problems of SOEC:

The steam supply of the SOEC, in particular due to its load behavior, is dependent on the availability of external steam from a synthesis device coupled to the SOEC. In times of high steam demand of the SOEC, it is possible that no or only insufficient amounts of steam are supplied by the synthesis arrangement coupled to the SOEC.

Furthermore, in the prior art, the unused residual heat from the SOEC process is not used for the reduction of the external steam requirement, so that exclusively only externally generated steam is available here and the internal SOEC residual heat quantities remain unused. In this regard, it has also been found that low-temperature heat (temperatures below 100° C.) are not usable for the steam supply within an SOEC.

Problems of the SOFC:

It is not possible to control the actual temperature required, i.e., the preheating temperature, for the gases to be supplied, namely air and hydrogen, so that only a rudimentary control with considerable uncertainties according to the prior art can occur here, which in turn leads to possible damage of the SOFC cell (stack). There is the risk that during rapid load changes due to impermissibly high temperatures, thermal stress can occur within the fuel cells whereby these can be destroyed.

Problems of rSOC:

The rSOC is dependent on the external steam supply both in terms of availability and load behavior.

The residual heat from the SOEC mode of an rSOC is not used for the reduction of the external steam requirement and is vented unused.

The low-temperature heat is not used, in particular the low-temperature heat is also not used for supplying the steam.

The residual heat from the SOFC mode of the rSOC is not used to supply the steam in the SOEC mode, so that considerable unused heat quantities are not used synergistically in this case in order to become independent from an external steam supply.

The hydrogen generation in the SOEC mode of the rSOC is not used for the hydrogen supply in the SOFC mode, but only externally supplied hydrogen is consumed in the prior art.

Overall, therefore, there is the impossibility of independence from an external steam and hydrogen supply for an rSOC in the prior art. This non-existent independence is therefore a major problem for rSOC.

It was also recognized that the pre-heating temperature for the necessary gases, namely air and hydrogen, cannot be controlled in the state of the art in the SOFC mode of the rSOC, which means that the rSOC in the SOFC mode there is the risk, that at rapid load changes due to impermissibly high thermal voltages could result in damage to fuel cells.

The present invention is concerned with the task of overcoming the above listed prior art problems recognize on the part of the applicant, in particular to make useable the internal unused or unusable appearing amounts of heat released unused to external consumers and/or to the environment in the prior art, for the internal supply of a SOEC, SOFC and/or rSOC.

This object is achieved with a heat management method according to the main claim and a high-temperature steam electrolysis [SOEC], solid oxide fuel cell [SOFC] and I or reversible high-temperature fuel cell the operating modes SOEC and SOFC [rSOC] arrangement according to the subordinate claims.

Internal generation of required steam is effected by internally recuperative heating and evaporation of externally supplied water, for which purpose the energy from the at least one cooling of the at least one exhaust stream to be cooled is used, and the external steam feed is thereby reduced or switched off.

The steam generated internally in the operating mode SOFC of an rSOC can be stored, preferably in a Ruth accumulator, and can be reused at a later time in the process mode the SOEC. The same applies to a corresponding combination system consisting of an SOFC system part and a SOEC system part which are combined with one another.

By the use of a Ruth accumulator tank in the supply of SOEC with steam from external sources the temporal differences between steam supply and steam consumption, which can be attributed to different load characteristics of steam generation and steam use, can be compensate for. Up to now, such deviations have led to the fact that excess steam has not been used or, in the case of steam deficiency, the electrolysis could not supply the necessary hydrogen requirement.

The use of the waste heat from a SOEC or from the operating mode SOEC of an rSOC for the steam generation and utilization of this steam in the electrolysis reduces the steam requirement of the electrolysis. Up to now, the waste heat that has not been used has been released to the environment. The steam generated internally during the SOEC process can be used directly in the process modes of the SOEC.

Heat from an air-oxygen exhaust stream and/or from a hydrogen-steam exhaust stream and/or air-nitrogen exhaust stream, preferably from all exhaust gas streams, is used recuperatively for steam generation.

By utilizing the available waste heat streams of an rSOC in fuel cell and electrolysis mode or a SOEC and/or SOFC for generating steam and storing the steam from the fuel cell mode in a storage tank or storing the exhaust steam from the reaction of the hydrogen with the oxygen from the fuel cell mode in a steam pressure accumulator for later use in the electrolytic mode, the steam requirement in the electrolytic mode is decreased and an rSOC and/or a SOEC becomes independent of an external steam supply.

The use of the waste heat of an SOFC for steam generation or the use of the exhaust steam from the reaction of the hydrogen with the oxygen can serve to supply an external SOEC and/or an external consumer with steam. Storage is also useful when the steam consumption by the external consumer fluctuates over time.

Furthermore, by means of these measures, an external steam supply of an rSOC (or an SOEC, in particular combined with an SOFC) compensates for temporal differences between steam supply and steam consumption, which are attributable to different load characteristics of steam generation and steam use. Up to now, such deviations have led to the fact that excess steam has not been used or, in the case of steam deficiency, the electrolysis could not supply the necessary hydrogen output.

With the simultaneous storage of the hydrogen generated in the SOEC mode of a rSOC in a pressure accumulator, the rSOC (or a SOEC, in particular combined with an SOFC) can be operated largely independently of an external steam and hydrogen supply for compensating load fluctuations in the power distribution network.

Heat sources (referring herein predominantly to external not yet used as well as internal not yet used ones) with temperatures below 100° C. can be used for internal steam production, a water evaporation being carried out at low pressures, in particular below 1 bar, wherein a subsequent pressure increase of the produced steam to the operating pressure of the electrolysis is effected, or an electrolysis takes place at low pressures, in particular below 1 bar, wherein the formed electrolysis products, at least hydrogen, in particular separated are compressed to the precipitation pressure, in particular can be submitted to a pressure increase prior to a further processing.

Furthermore, heat sources with temperatures below 100° C. can be used internally for the production of steam, wherein the temperature level of the heat source is raised by means of a heat pump process to a level usable for steam generation for the electrolysis. For the production of steam, the energy of the heat sources with temperatures below 100° C. is only made use of by means of the heat pump process.

Furthermore, heat sources with temperatures below 100° C. can be used internally for the production of steam, wherein an internal circulation of the products downstream of the cell, in particular the hydrogen, is used as the carrier gas for steam production by evaporation at the temperature level of the heat source, and thus low temperatures are sufficient to produce steam internally.

Regulated recuperative heating of air and/or hydrogen can take place, in particular, in an SOFC and in the SOFC operation of an rSOC with larger-dimensioned recuperators, wherein a bypass flow of the temperature-controlled air and/or the hydrogen is directed around the larger dimensioned recuperator. By controlling the preheating temperature for the air and the hydrogen, thermal stresses in the stack (the fuel cell stack) of an SOFC or rSOC in the SOFC mode are avoided. As a result, larger load zones can be traversed faster without the risk of damage to the stack or a loss in performance.

According to the invention, at least one water evaporation device, a steam generator and/or a heat exchanger for generating steam is/are arranged in at least one gas removal duct in order to produce steam.

In a preferred embodiment, steam producing devices are provided in both exhaust gas lines.

The arrangement or the method is particularly advantageously applicable for use in a reversible solid oxide cell [rSOC] or a combined SOFC/SOEC arrangement. According to the invention, the exhaust gas heat from the SOFC operation is used for the generation of pressure steam, which can preferably be buffered in a storage tank in order to reuse the steam in the subsequent SOEC operation as process steam.

At the same time, the exhaust heat exchanger installed for steam generation in SOFC operation is also used for steam generation in the SOEC operation, so that the overall steam demand for the electrolysis decreases.

The steam evaporator arrangement, the steam generator and/or the heat exchanger for steam generation is arranged in at least one, preferably in both gas discharge lines, downstream of a recuperative preheater for preheating gas to be supplied to the electrolysis/fuel cell. In particular for a SOEC or rSOC in SOEC mode, the residual heat from the air-O₂ exhaust stream and the hydrogen-steam gas stream is used to generate steam which is used immediately in the SOEC for the production of hydrogen or, with a suitable dimensioning of the water evaporation arrangement, can be stored temporarily, as a result of which the overall external steam requirement of the SOEC decreases.

A heat accumulator/buffer, a Ruth accumulator, a gas pressure accumulator with an upstream compressor, a high-temperature accumulator, a latent heat accumulator and/or a thermochemical heat accumulator can be provided for storing generated steam, the accumulator being particularly suitable for balancing out the different load states and bridging the time between production and use is required. In this way, it is possible to operate a SOEC, which is independent of external steam supply, in combination with an SOFC and/or rSOC. Furthermore, a time-shifted use of steam from the SOFC mode of an rSOC in the SOEC mode is possible by means of a gas pressure accumulator for storing the exhaust steam from the fuel cell reaction. In this case, the steam is particularly advantageously compressed before storage and/or the two operating modes are operated at different pressures.

Furthermore, a water evaporation arrangement with a low-temperature heat supply from the SOEC, SOFC and/or rSOC or from an external heat source, which has hitherto not been usable for steam production, can be provided for this, wherein the pressure of steam produced therein depending on the temperature of the heat source is less than 1 bar, wherein a compressor is provided downstream of the water evaporation arrangement, which increases the pressure of the generated steam to process pressure or the pressure in the subsequent electrolysis cell [SOEC] in which the steam produced is to be used is below 1 bar and which after the electrolysis cell [ SOEC] respectively a compressor is provided which increases the pressure of the electrolysis gases and/or of the resulting electrolysis gases to ambient pressure.

For the use of heat sources with a temperature of <100° C. for the steam supply of a SOEC, either
the water evaporation is carried out at a lower pressure (<1 bar), and the steam is subsequently compressed to the pressure required for the SOEC,
water evaporation and electrolysis are carried out at a lower pressure (<1 bar) and the products (oxygen, hydrogen) are compressed to ambient pressure after electrolysis,
a heat pumping process is used to boost the low temperature heat to the temperature level, so that steam generation is possible at temperatures >100° C. and thus at process pressure of the SOEC,
   or
by using an internal circulation of hydrogen, an evaporation of the water at the temperature level of the heat source can be carried out, using the circulating hydrogen as a carrier gas for steam production, to use the steam. The partial pressure of the steam in the carrier gas is determined by the temperature level of the heat source.

Furthermore, a supplemental heat pump arrangement can also be provided, which with input of energy brings the low-temperature heat at T<100° C. to a higher temperature level to use as heat for evaporation of water at the process pressure of the SOEC.

The above-described technical measures for the use of low-temperature heat make this usable for the steam supply of the SOEC or rSOC. Up to now, low-temperature heat was not usable for steam generation for a SOEC or rSOC.

In one embodiment, for the internal storage of hydrogen, a hydrogen storage is provided in a preferred form as a gas pressure accumulator. By the integration of the steam accumulator device according to the invention and the use of the hydrogen storage device (e.g. gas pressure accumulator), the reversible high-temperature fuel cell [rSOC] or SOEC/SOFC combination can be operated with steam and hydrogen as a function of the selected storage variables.

The residual hydrogen which may be present in the exhaust steam due to a not complete conversion of fuel from the fuel cell operation can either be buffered together with the steam in the pressure reservoir or can be separated from the steam-H₂ mixture by a suitable gas separation process prior to the buffering of the steam.

For the operation of a high-temperature fuel cell [SOFC] or a rSOC in the SOFC mode, the required air and the required hydrogen can be recuperatively preheated with hot exhaust gas to ensure the minimum temperature and to avoid unacceptable thermal stresses in the stack (fuel cell stack). In order to avoid deviations from the optimum preheating temperature during load changes, the recuperators can be dimensioned larger, in order to control the preheating temperature for the air and the hydrogen by means of a bypass flow around the respective recuperators.

Even if an external steam and/or hydrogen supply is present, fluctuations in the steam and hydrogen supply can be compensated by these storage technologies.

The essential advantages of the invention and of the particular embodiments described can also be illustrated in a further embodiment, as explained in the following, which is not intended to be exhaustive:

Special advantages for SOEC and rSOC in SOEC mode:
by steam accumulator, in particular a Ruth accumulator, an SOEC becomes more independent of the availability and the load behavior of the external steam supply,
by using residual heat from the SOEC process for steam generation and by utilization of the generated steam in the SOEC process, the external steam demand decreases,
through the proposed technical solutions more cost-effective and more available low-temperature heat can be used for steam generation for a SOEC

Special advantages for SOFC and rSOC in SOFC mode:
by regulating the air and hydrogen preheating temperatures for the SOFC greater load changes can be carried out without the risk of destroying cells of the fuel cell stack

Special advantages for rSOC:
via the Ruth accumulator a rSOC becomes more independent of the availability and the load characteristics of the external steam supply,
previously unused residual heat from the SOFC mode is used to supply the steam in the SOEC-mode,
hydrogen generation in the SOEC mode is used for the hydrogen supply in the SOFC mode,
an independence from an external steam and hydrogen supply is possible

In particular, it should also be pointed out that such a process or an SOFC, SOEC and/or rSOC formed in this way is particularly suitable for connecting with a plant for the production of synthetic hydrocarbons, wherein in particular a Fischer-Tropsch or methane synthesis plant, in particular operated with electrical energy from regenerative energy sources, which are subject to corresponding fluctuations (solar, wind energy), are to be mentioned. Thus, the plant can be a constituent of a hydrocarbon synthesis plant, in particular in the synthesis process with regeneratively produced electrical energy, the external steam coming predominantly from the hydrocarbon synthesis plant.

In the following in the description of the figures embodiments of the invention will be described in detail on the basis of the accompanying drawings, which are intended to illustrate the invention and are not to be regarded as limiting:

Therein:

FIG. 1 shows a schematic representation of an exemplary embodiment of a SOEC (high-temperature water-vapor electrolysis);

FIG. 2 shows a schematic representation of an exemplary embodiment of an SOFC (fuel cell);

FIG. 3 shows a schematic representation of an exemplary embodiment of the SOEC with a Ruth accumulator for storing external steam and internal steam generation for reducing the external steam demand;

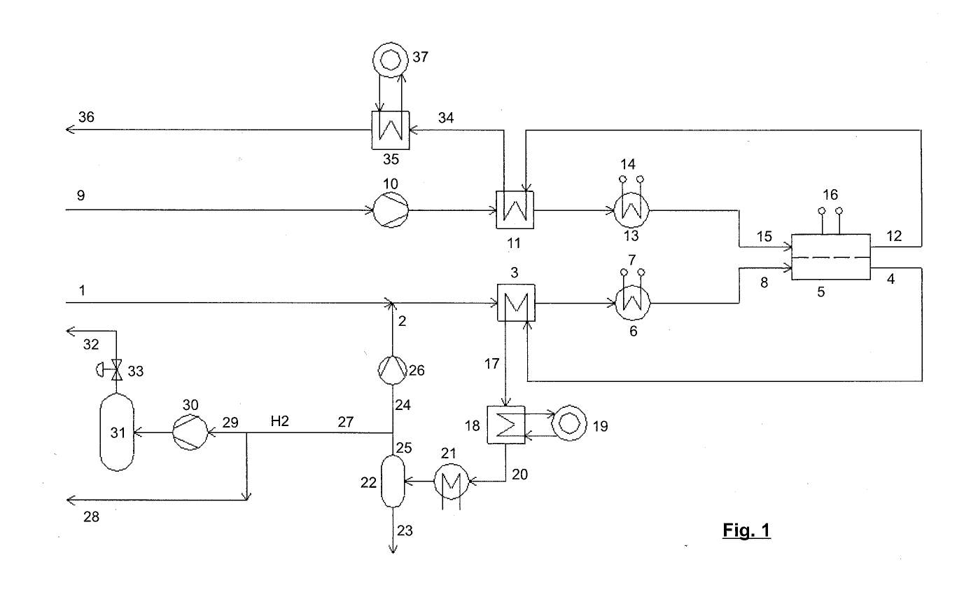

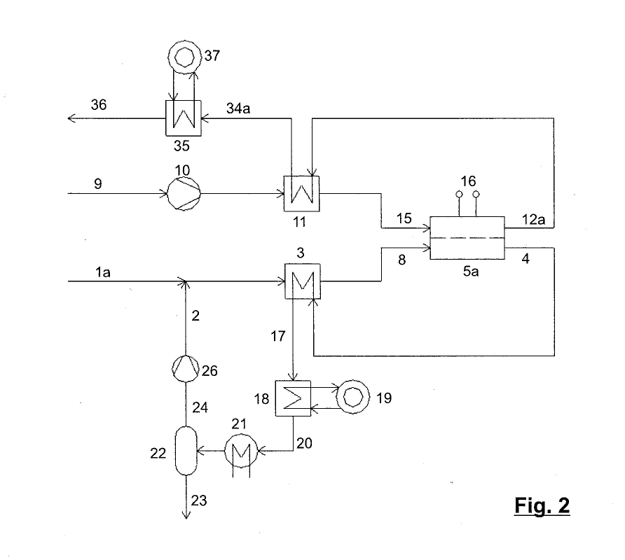

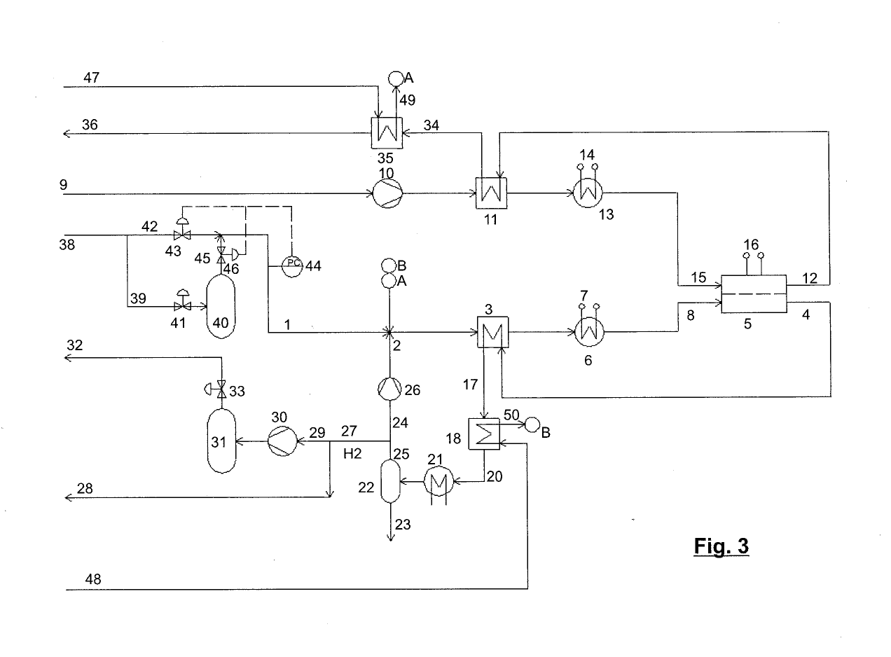

FIG. 4 shows a schematic representation of a first exemplary embodiment for the use of low-temperature heat for steam generation for a SOEC;

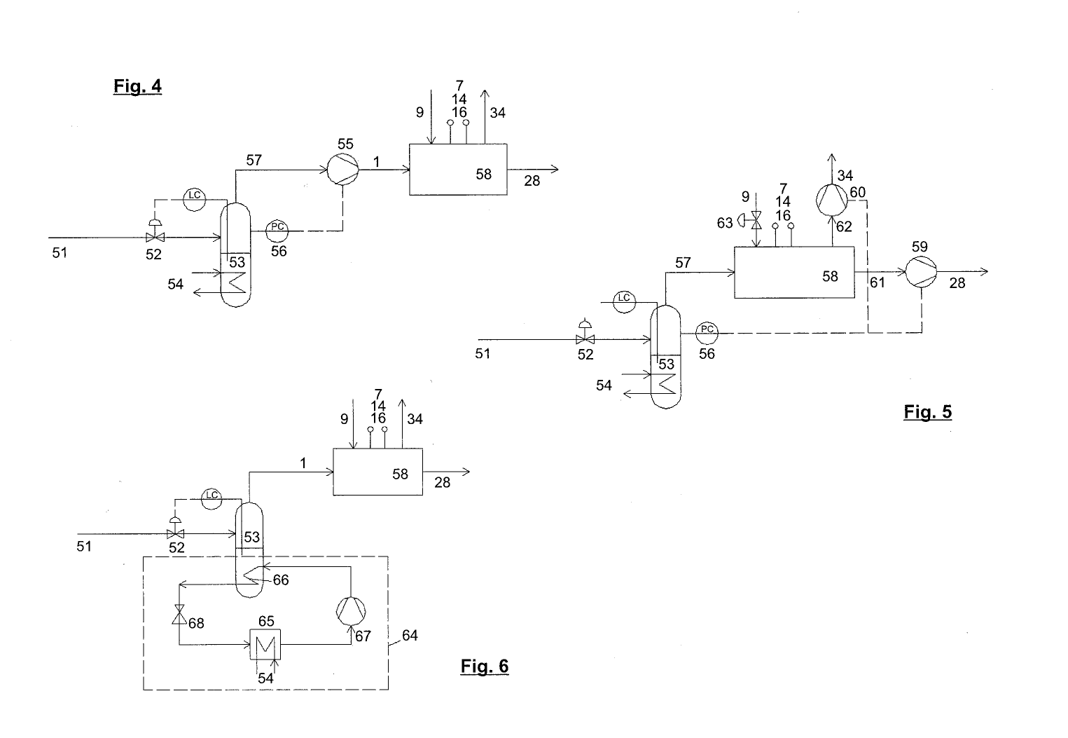

FIG. 5 shows a schematic representation of a second exemplary embodiment for utilizing low-temperature heat for steam generation for a SOEC;

FIG. 6 shows a schematic representation of a third exemplary embodiment for utilizing low-temperature heat for steam generation for a SOEC;

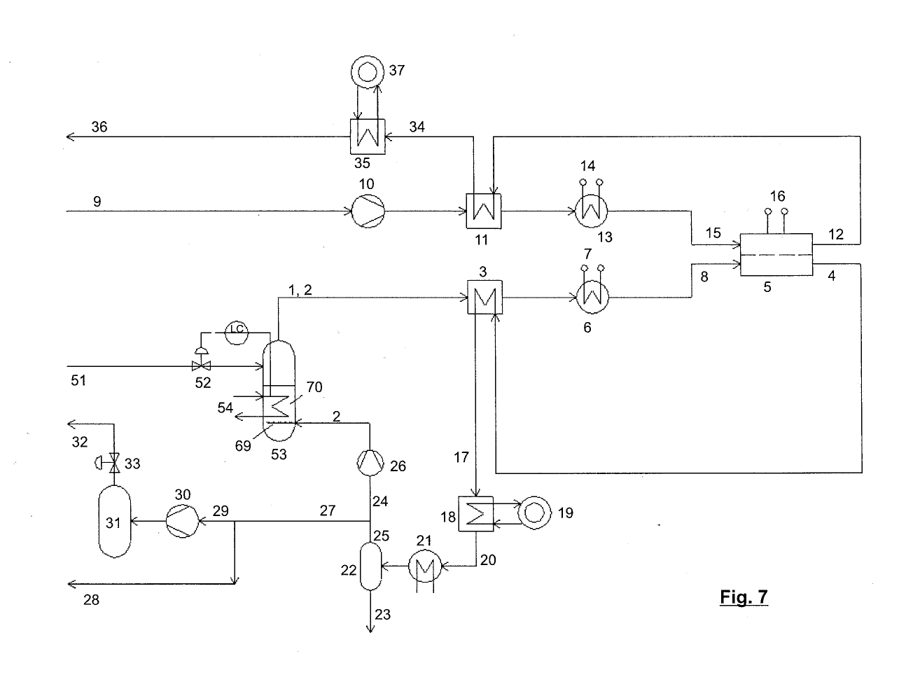

FIG. 7 shows a schematic representation of a fourth exemplary embodiment for the use of low-temperature heat for steam generation for a SOEC;

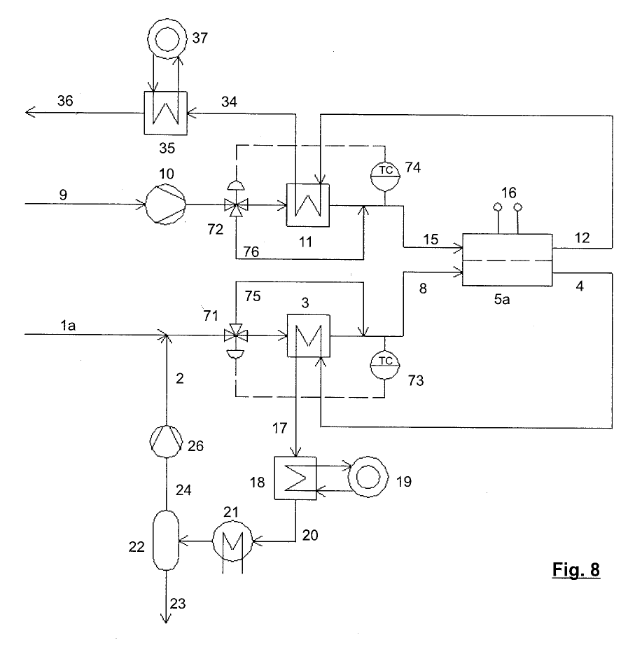

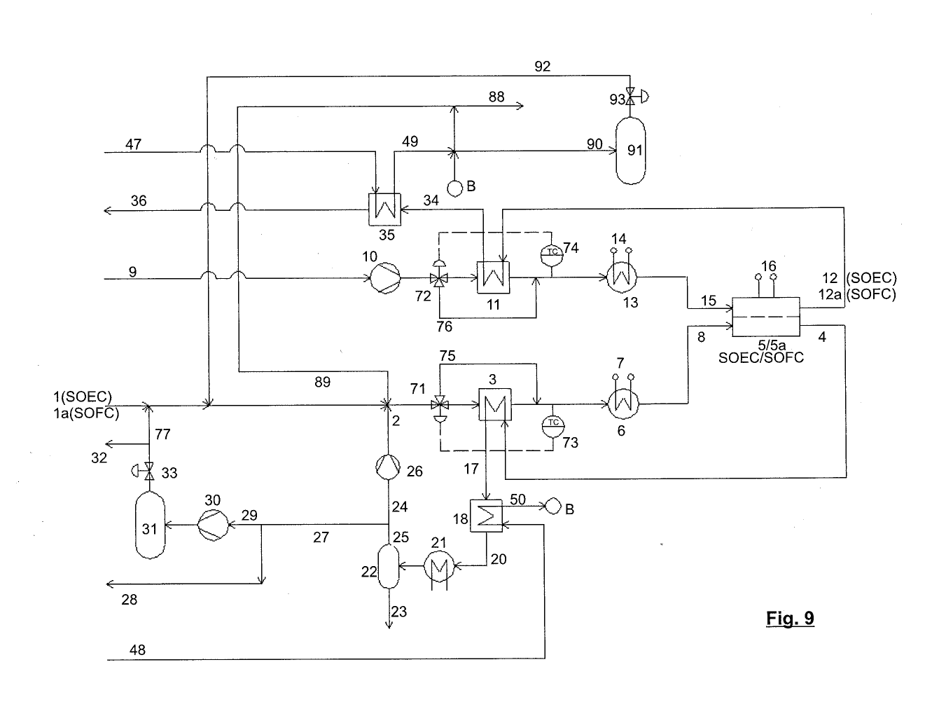

FIG. 8 shows a schematic representation of an exemplary embodiment for controlling the preheating temperature for the air and the hydrogen in an SOFC;

FIG. 9 shows a schematic representation of an exemplary embodiment of an rSOC (reversible high-temperature fuel cell) with an eternal steam supply and Ruth accumulator as well as controlled air and hydrogen preheating in the SOFC mode and

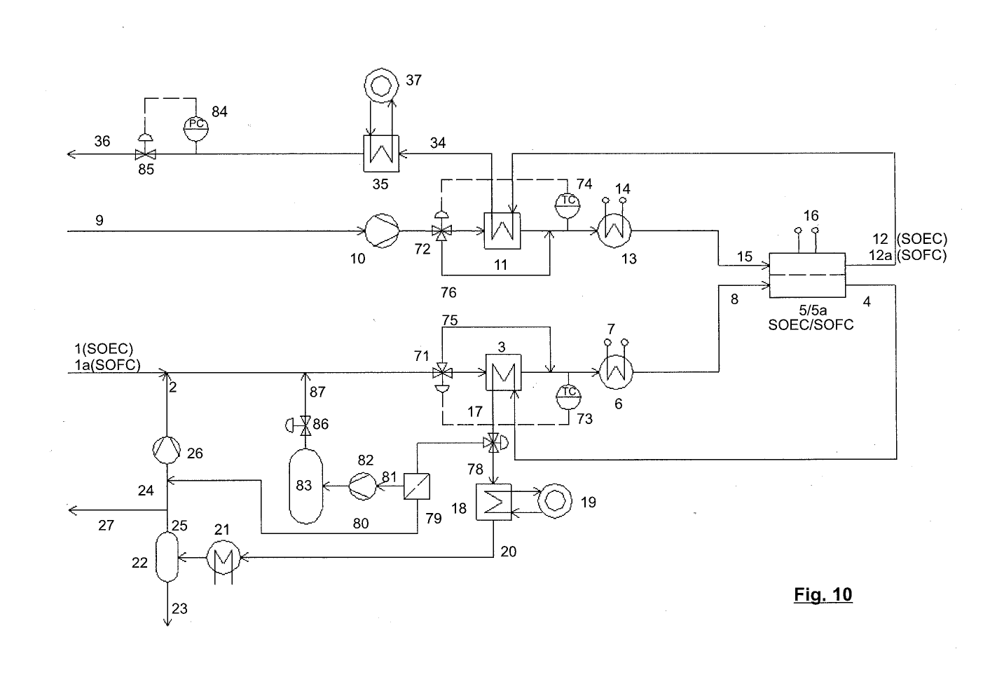

FIG. 10 shows a schematic representation of an exemplary embodiment of a storage of the steam or of the steam-hydrogen mixture from the fuel cells in the SOFC mode of an rSOC for later use in the SOEC mode.

In FIG. 1 is a schematic representation of a prior art embodiment of a SOEC (high-temperature steam electrolysis) is shown.

Steam 1 is mixed with a small amount of recirculated hydrogen 2 and preheated as high as possible in the recuperative preheater 3 against hot hydrogen-steam mixture 4 from the electrolysis cells 5 and subsequently heated in the heater 6 with electroenergy 7 up to electrolysis cell inlet temperature 8.

Purge air 9 is increased in pressure with a blower 10 and recuperatively preheated as high as possible in the air preheater 11 against the hot air-O₂ mixture 12 from the electrolytic cell 5. In the heater 13, the further heating of the scavenging air with electric energy 14 takes place up to the electrolysis cell inlet temperature 15.

In the electrolysis cells 5, the hot steam 8 is decomposed into hydrogen and oxygen using electrical energy 16. The oxygen leaves the electrolysis cells 5 as an air-02 mixture 12 and the hydrogen with the unreacted residual steam as the hydrogen-steam mixture 4.

The hydrogen-steam mixture 17 cooled in the heat exchanger 3 is optionally further cooled in a heat exchanger 18. The dissipated heat can be supplied to an external heat utilization 19.

In the cooler 21, the gas mixture 20 from the heat exchanger 18 is cooled to such an extent that a large portion of the steam contained in the gas mixture 20 condenses and is deposited as condensate 23 in the subsequent phase separator 22.

A partial stream 24 of the hydrogen leaving the phase separator 22 is increased in pressure with the blower 26 and admixed as stream 2 to the steam 1.

Alternatively, if the blower 26 is suitable for higher temperatures, it can recirculate a partial stream of hydrogen-steam mixture downstream of the heat exchanger 3 or 18 instead of the stream 24. This also recirculates an increased proportion of unreacted steam, which reduces the external steam requirement 1.

The main quantity of hydrogen 27 is either transferred directly as a hydrogen stream 28 to a consumer or the entire quantity or a partial quantity 29 is compressed in a compressor 30 and buffered in the pressure accumulator 31, from which the hydrogen is withdrawn later in time as stream 32 via the pressure control valve 33 and sent to a consumer.

The air-O₂ mixture 34 cooled in heat exchanger 11 is further cooled in optional heat exchanger 35 and discharged as exhaust gas 36 to the environment. The heat from the heat exchanger 35 can be supplied to an external heat user 37.

In FIG. 2 is a schematic representation of a prior art embodiment of a SOFC (fuel cell) is shown.

Hydrogen 1a is mixed with unreacted and recirculated hydrogen 2 and preheated in the recuperative preheater 3 against hot water/steam/hydrogen mixture 4 from the fuel cells 5a up to the fuel cell inlet temperature 8.

Air 9 is increased in pressure by means of a blower 10 and preheated recuperatively in the air preheater 11 against the hot air-nitrogen mixture 12a from the fuel cells 5a to the fuel cell inlet temperature 15.

In the fuel cells 5a, the hot hydrogen 8 reacts with a part of the air oxygen 15 to form steam. This produces electrical energy 16, which is delivered to the power supply grid or to consumers.

The formed steam and the unreacted hydrogen are contained in the hot stream 4 leaving the fuel cells 5a.

The steam-hydrogen mixture 17 cooled in the heat exchanger 3 is optionally further cooled in a heat exchanger 18. The dissipated heat can be supplied to an external heat utilization 19.

In the cooler 21, the gas mixture 20 from the heat exchanger 18 is cooled to such an extent that a large portion of the steam contained in the gas mixture 20 condenses and is deposited as condensate 23 in the subsequent phase separator 22.

The remaining hydrogen 24 from the phase separator 22 is increased in pressure with the blower 26 and admixed as a stream 2 to the hydrogen 1a for increasing the fuel utilization.

The hot gas stream 12a leaving the fuel cells 5a contains the residual air with a higher nitrogen content since a part of the air oxygen has bonded to the hydrogen.

After cooling this gas stream 12a in the heat exchanger 11, it is supplied as a stream 34a to the optional heat exchanger 35 for further cooling and then leaves the process as the exhaust stream 36.

The heat from the heat exchanger 35 can be supplied to an external heat supply 37.

The prior art for reversible high-temperature fuel cell (rSOC) corresponding to FIGS. 1 and 2:

The reversible high-temperature fuel cell (rSOC) corresponds to the diagram in FIG. 1, wherein the SOEC mode corresponds to the description of FIG. 1. The description of the SOFC mode essentially corresponds to the description of FIG. 2, wherein the electric heaters 6 and 13 are not in operation and are only flowed through in the SOFC mode.

The hydrogen discharge 27 and 28 as well as the hydrogen compressor 30 are likewise not in operation in the SOFC mode.

Reference is made to the descriptions of the FIGS. 1 (SOEC) and 2 (SOFC), which show the basic functions and conceptualities, as the basis for the following figures.

FIG. 3 shows a schematic representation of an embodiment of a SOEC of FIG. 1 with a Ruth accumulator for storing externally and internally generated steam for the reduction of the external steam requirements.

The pressure steam 38, which is produced in an external steam generator, is to be used as steam 1 for a SOEC. The load behavior of the external steam generation differs from the load behavior of the SOEC so that, with respect to the steam demand of the SOEC, there is at one time more and at another time less steam available from the external steam generation.

In order to balance to the steam demand for the SOEC, the excess pressure steam 39 supplied from the external steam generation is to be temporarily buffered in a heat accumulator 40.

The heat accumulator 40 is, for example, a sliding-pressure accumulator (Ruth accumulator) filled with boiling water and saturated steam. Other suitable heat accumulators are, for example, stratified storage tanks, liquid salt storage tanks and thermochemical storage tanks.

During the charging process the excess pressure steam 39 is added through the valve 41 into the accumulator 40. The remaining steam 42 is reduced via the throttle valve 43 to the pressure 44 and used as steam 1 for SOEC.

At the beginning of the charging process boiling water and saturated steam at the steam output pressure 44 are in the accumulator 40. Due to the additional introduction of pressurized steam 39, the boiling water in the accumulator 40 is heated and the pressure in the container increases. The maximum possible pressure corresponds to the pressure of the supplied pressure steam 39. Due to the pressure increase, the vapor portion is reduced and the water content increased in the container. The supplied heat is stored in the form of boiling water (principle of a Ruth accumulator).

If there is a steam deficiency in the SOEC, because the external steam generation directly provides too little steam, then the throttle valve 45 is opened at the accumulator 40 and the desired difference in amount of 46 steam is removed from the heat accumulator 40.

Through the removal of steam, the pressure in accumulator 40 is reduced, and boiling water is evaporated in the tank. A steam removal is possible up to the pressure 44.

After steam removal, the heat accumulator 40 can be recharged.

To reduce the external steam requirement 1, the heat exchangers 18 and 35 can be used, instead of providing heat for external users, to generating steam. For this purpose, feed water 47 and 48 is added to the respective heat exchangers 35 and 18. The generated steam 49 and 50 is mixed into the vapor stream 1 at A or B to the heat exchanger 3 resulting in a reduction of the required amount of steam 1.

In order to use lower temperature heat for evaporation of water and to supply of SOEC with steam, the following 4 embodiments are configured according to FIG. 4 to FIG. 7, wherein the illustrated evaporators are one possible embodiment, and other suitable evaporators may also be used.

FIG. 4 shows a schematic representation of a first embodiment for the use of low temperature heat to generate steam for a SOEC of FIG. 1.

The fill-level of feed water 51 introduced into an evaporator 53 is controlled by a throttle valve 52, which is heated with low-temperature heat 54. With a suction blower 55, a vacuum 56 is set in the evaporator 53, which is so high that the feedwater 51 heated with low temperature heat 54 is evaporated. The resulting low pressure steam 57 is sucked to the blower 55, is compressed and fed as process steam 1 with the required over-pressure to the SOEC 58 where it is separated with the electric energy 7, 14 and 16 into hydrogen 28 and oxygen, which via purge air 9 is discharged from the SOEC as an air-oxygen mixture 34.

FIG. 5 shows a schematic representation of a second embodiment for the use of low temperature heat to generate steam for a SOEC of FIG. 1.

Feed water 51, of which the level is controlled by a throttle valve 52, is introduced into an evaporator 53, which is heated with low-temperature heat 54. With the two suction fans 59 and 60, a vacuum 56 is set in the evaporator 53, which vacuum is so high, that the feedwater 51 with the low temperature heat 54 turns to steam. The resulting low pressure steam 57 is evaporated is sucked with the blowers 59 and 60 and supplied, at low pressure, to SOEC 58, which is operated at negative pressure.

In the SOEC 58 the steam 57 is decomposed with electrical energy 7, 14 and 16 into hydrogen 61 and oxygen 62. To flush the SOEC, purge air 9 is used, which is relaxed via the throttle valve 63 to the operating pressure of the SOEC 58. The blower 59 compresses the hydrogen 61 to the output state 28 and the blower 60 the oxygen 62 and the purge air to the discharge state 34.

In FIG. 6 is a schematic representation of a third embodiment is shown for the use of low temperature heat to generate steam for a SOEC according to FIG. 1.

To boost the temperature level of the low temperature heat 54 so that an evaporation of the feed water 51 is possible at temperatures >100° C., a heat pump 64 can be employed. Heat pumps are available as compact units consisting of evaporator 65, condenser 66, compressor 67 and throttle valve 68, and can be adapted to the respective requirements.

The steam 1 produced in the evaporator 53 is generated with the parameters required for the SOEC 58 and can be used directly in this.

FIG. 7 shows a schematic representation of a fourth embodiment for the use of low temperature heat to generate steam for a SOEC of FIG. 1.

Feed water 51 level-controlled by the control valve 52 is supplied to the steam generator 53, which is heated with low-temperature heat 54.

The recirculated quantity of hydrogen 2 is finely distributed through distributing elements 69, which are housed in a water bath 70 of the steam generator 53, into the water bath 70 heated with low-temperature heat 54. The hydrogen 2 flows through the water bath 70 and takes up steam 1 up to the saturation pressure of the respective water bath temperature. The hydrogen-steam mixture 1+2 is supplied to the following process stages of SOEC.

In order to supply the required amount of steam to the process, the recirculated amount of hydrogen 2 must be increased and adapted as a function of the temperature level 54 of the low temperature heat.

Alternatively, the blower 26, if it is suitable for higher temperatures, can recirculate a partial stream of hydrogen-steam mixture after the heat exchanger 3 or 18 rather than stream 24. Thus, an increased proportion of unreacted hydrogen is used again, reducing the heat demand 54 for the evaporation of water.

FIG. 8 shows a schematic representation of an embodiment for controlling the preheating temperature of the air and hydrogen at a SOFC of FIG. 2.

So that during SOFC operation in case of deviations from the operating parameters of the heat exchangers 3 and 11 the air 15 and the hydrogen 8 do not arrive in the fuel cell 5a too hot or too cold, where they lead due to thermal stresses occurring thereby to destruction of the cells, the heat exchangers 3 and 11 are so dimensioned so that they bring at maximum load (amount of gas 8, or 15) at least the desired minimum preheating temperature for the streams 8 and 15. In the design for partial load it must be observed that the heat transfer throughput does not decrease faster than the necessary heat transfer area, so that the desired preheating temperature of the streams 8 and 15 is at least provided, but is preferably exceeded.

To set the desired preheating temperature in all load conditions, the control valves 71 and 72 are installed before the heat exchangers 3 and 11 in the respective gas streams supplied to the heat exchangers, which, depending on the desired target temperatures 73 and 74, bypass a cold partial stream of hydrogen 75 or air 76 around the respective heat exchanger and thereafter intermix in the hot gas, so that the respectively resulting mixing temperature corresponds to the predetermined desired temperature.

In FIG. 9 is a schematic representation of an embodiment of an rSOC (reversible high temperature fuel cell) with own steam supply and Ruth accumulator and controlled air as well as hydrogen warming in SOFC mode.

Electrolysis mode (SOEC mMode):

Steam 1 is mixed with a small amount of recirculated hydrogen 2 and preheated in a recuperative preheater 3 with hot hydrogen-steam mixture 4 from the electrolytic cell 5, and then pre-heated in the heater 6 with electric power 7 to the electrolysis cell inlet temperature 8.

The control of the preheating temperature 73 is not in operation in SOEC mode, since a maximum preheating in heat exchanger 3 is desired for reducing the power requirements 7 for the heater 6. I.e., there is no hydrogen is passed around the heat exchanger 3 in the bypass 75.

Purge air 9 is increased in pressure with a blower 10 and recuperatively preheated in the air preheater 11 against the hot air-02 mixture 12 from the electrolysis cell 5. In the heater 13 the further heating of the gas mixture is effected with electric power 14 to the electrolysis cell inlet temperature 15.

The control of the preheating temperature 74 is also not in operation in SOEC mode, since a maximum preheating in heat exchanger 11 is desired to reduce the power demand 14 for the heater 13. I.e. no purge air passes around the heat exchanger 11 in the bypass 76.

In the electrolytic cell 5 the pre-heated steam 8 is decomposed under consumption of electrical energy 16 into hydrogen and oxygen. The oxygen leaves the electrolysis cell 5 with the scavenging air as an air-O₂ mixture 12 and the hydrogen with the residual steam as hydrogen-steam mixture 4.

The hydrogen-steam mixture 17 cooled in the heat exchanger 3 is further cooled in a heat exchanger 18. For heat dissipation feedwater 48 is heated and subsequently transformed into steam 50.

In the cooler 21 the gas mixture 20 from the heat exchanger 18 is cooled to the extent that a large part of the steam contained in the gas mixture 20 condenses and is deposited in the subsequent phase separator 22 as condensate 23.

A partial stream 24 of the hydrogen 25 leaving the phase separator 22 is increased in pressure by the blower 26 and as a steam 2 is mixed with the steam 1.

Alternatively, the blower 26, if it is suitable for higher temperatures, rather than stream 24, can recirculate a partial hydrogen steam mixture after heat exchanger 3 or 18. Therewith, an increased proportion of unreacted steam is used again, reducing the external steam requirement 1.

The main amount of hydrogen 27 from the phase separator 22 is either directly output as the hydrogen stream 28 to a consumer or the entire amount or partial amount 29 is compressed in a compressor 30 and stored in the pressure accumulator 31, from which the hydrogen is removed time-shifted via the pressure control valve 33 and either supplied as a stream 32 to an external consumer, or returned as a stream 77 to the process as hydrogen for a time-shifted SOFC operation.

The air-O₂ mixture 34 cooled in heat exchanger 11 is further cooled in heat exchanger 35 and discharged to the environment as exhaust gas 36.

The heat from the heat exchanger 35 is used to heat and evaporate feedwater 47. The generated steam 49 mixed together with the steam 50 (via B) is either supplied to an external user 88 or as a partial or total amount of 89 is I mixed with the steam supplied to the heat exchanger 3. Therewith, the steam 1 requirement is reduced for electrolysis cells 5. Storage as pressure steam 90 in a Ruth accumulator 91 is possible in principle, but not useful in the electrolysis operation case.

Steam 92, which has been previously stored in the operating mode fuel cell operation (SOFC mode) can be removed from the Ruth accumulator 91 via the throttle valve 93. This amount of steam 92 is mixed with the steam 1 and supplied to the heat exchanger 3 and reduces the steam demand for the electrolytic cell 5.

Fuel Cell Mode (SOFC Mode):

Hydrogen 1a is mixed with unreacted and recirculated hydrogen 2 and heated recuperatively in heat exchanger 3 with hot steam-hydrogen mixture 4 from the fuel cells 5a. To maintain a predetermined pre-heating temperature 73 under all load conditions, a bypass flow is guided through the control valve 71 around the heat exchanger 3 and mixed with the hot stream after the heat exchanger 3.

The subsequent heater 6 is not in operation and is therefore is not flowed through. The preheated hydrogen 8 reaches the fuel cell 5a.

Air 9 is increased in pressure with a blower 10 and in the air preheater 11 is recuperatively preheated against the hot air-N₂ mixture 12a from the fuel cell 5a. To maintain a predetermined pre-heating temperature 74 at all load conditions, a bypass flow is guided through the control valve 72 around the heat exchanger 11 and mixed with the hot stream after the heat exchanger 11.

The heater 13 likewise is not in operation and is not flowed through. The preheated air 15 also enters to the fuel cell 5a.

In the fuel cell 5a the hydrogen 8 reacts with a portion of the oxygen of air 15 to form water vapor. This produces electric energy 16 that is delivered to the electric grid or to consumers.

In the hot stream after the fuel cell 4, the is the formed steam and the unreacted hydrogen.

The steam-hydrogen mixture 17 cooled in heat exchanger 3 is further cooled in heat exchanger 18. For heat dissipation feedwater 48 is heated and transformed into steam 50.

In the cooler 21 the gas mixture 20 from the heat exchanger 18 is cooled to the extent that a large part of the steam contained in the gas mixture 20 condenses and is deposited in the subsequent phase separator 22 as condensate 23.

The remaining hydrogen 24 from the phase separator 22 is fully raised in pressure by the blower 26 and mixed as stream 2 into the hydrogen 1a to increase the fuel utilization.

The hot gas stream 12a leaving the fuel cell 5a includes the remaining air with a higher nitrogen content, since a part of the atmospheric oxygen has bonded to the hydrogen. After cooling of this gas stream 12a in heat exchanger 11 it is fed as stream 34 to the heat exchanger 35 for further cooling and then leaves the process as waste gas stream 36.

The heat from the cooling of the gas in the heat exchanger 35 is used to heat and evaporate the feedwater stream 47. The generated steam 49 is supplied together with the steam 50 either to external users 88 or buffered as stream 90 in Ruth accumulator 91 for later use in the electrolysis mode.

The hydrogen stored in the pressure accumulator 31 in the electrolysis mode (SOEC) can be taken from the accumulator in the fuel cell mode, and be mixed as stream 77 into the hydrogen stream 1a. Therewith the required external amount of hydrogen 1a is reduced accordingly.

FIG. 10 shows a schematic representation of an embodiment of an accumulator for the steam or the steam-hydrogen mixture from the fuel cells in the SOFC mode of rSOC for later use in a SOEC mode.

Another possibility of storing heat (steam) from the fuel cell operation (SOFC) for the electrolysis operation (SOEC) ore a rSOC is the use of a gas pressure accumulator to store the steam or steam-hydrogen mixture from the SOFC operation. Here, two cases are conceivable:

a) compression of the steam before storage and
b) SOFC operating at a higher pressure than the operating SOEC.
A combination of cases a) and b) is also possible.

Fuel Cell Mode (SOEC):

If the fuel cell mode (SOEC) of the rSOC is operated at elevated pressure, then hydrogen 1 is fed as pressurized hydrogen to the rSOC and the blower 10 for increasing the pressure of the air 9 is designed for a larger pressure increase.

The steam-hydrogen mixture 17 cooled in heat exchanger 3 may go either the classical pathway via the heat recovery 18, cooling 21 and the recirculation 26 of residual hydrogen, or be routed via the valve 78 to an optional gas separation 79.

In the optional gas separation 79 the residual hydrogen 80 contained in the gas stream 17 is separated from the steam-hydrogen mixture and supplied to the blower 26 for recirculation and thus better hydrogen utilization in the SOFC process. After the pressure increase of the hydrogen is added as stream 2 to the hydrogen stream 1.

The remaining steam 81 or, in the case of omission of the gas separation 79, the steam-hydrogen mixture 17, can be increased in pressure by means of compressor 82 and goes into a gas pressure accumulator 83, where the gas or the gas mixture is buffered for the SOEC mode. The gas compressor 82 may be omitted if the SOFC operation of the rSOC is carried out at a higher pressure than the SOEC operation.

At this point a further possible configuration should be mentioned, namely that the compressor 82 can also be omitted if the SOEC operation takes place at a lower pressure than the SOFC operation.

The compressed gas reservoir is full when the SOFC operating pressure or the maximum compressor discharge pressure of the compressor is achieved 82.

During operation of the SOFC mode under elevated pressure, a pressure control valve 85 is located on the exhaust side of the SOFC process in the stream 36 to maintain the system pressure 84.

Electrolysis Mode (SOEC):

The electrolysis mode (SOEC) is carried out at a lower pressure than the pressure in the compressed gas storage 83.

By opening the throttle valve 86 on the compressed-gas accumulator 83 the steam/steam-hydrogen mixture 87 previously stored in the SOFC mode is fed to the SOEC process and may completely or partially replace the steam stream 1.

The gas pressure accumulator 83 is discharged when the pressure in the accumulator is equal to the pressure of the rSOC in SOEC mode.

### Another Embodiment

In the following the invention will be described based on a concrete embodiment and with inclusion of the aforementioned figures as well as the following diagrams:

Numerical Example of an Inventive rSOC:

SOFC Mode

| | | | |
|---|---|---|---|
| Hydrogen (1a): | Mass flow | 3.19 | kg/h |
| | Power (Hu): | 105.8 | kW |
| Air (9): | Flow rate: | 611.4 | kg/h |
| Heat exchanger (3): | Power: | 11.8 | kWₜₕ |
| Heat exchanger (11): | Power: | 105.1 | kWₜₕ |
| Heat exchanger (35): | Power: | 13.2 | kWₜₕ |
| Heat exchanger (18): | not considered | | |
| Heater (6): | Power: | 0 | kWₑₗ |
| Heater (13): | Power: | 0 | kWₑₗ |
| Fuel cell (16): | Power: | 72.6 | kWₑₗ |
| Feedwater (47): | Flow rate | 20.2 | kg/h |
| | Pressure: | 10 | bar (a) |
| | Temperature: | 100° | C. |
| Steam (90): | Flow rate | 20.2 | kg/h |
| | Pressure: | 10 | bar (a) |
| | Saturated steam | | |

SOEC Mode

A fuel cell with above listed performance parameters has according to experience the following parameters in the electrolysis mode:

| | | | |
|---|---|---|---|
| Steam (1): | Mass flow: | 33.4 | kg/h/h |
| | Pressure: | 2 | bar (a) |
| | Saturated steam | | |
| Purge air (9): | Mass flow: | 62 | kg/h |
| Heat exchanger (3): | Power: | 15.1 | kWₜₕ |
| Heat exchanger (11): | Power: | 13.3 | kWₜₕ |
| Heat exchanger (35): | Power: | 6.0 | kWₜₕ |
| Heat exchanger (18): | not considered | | |
| Heater (6): | Power: | 5.0 | kWₑₗ |
| Heater (13): | Power: | 0.6 | kWₑₗ |
| Electrolytic cell (16): | Power: | 130.9 | kWₑₗ |
| Hydrogen (28): | Mass flow: | 3.85 | kg/h |
| | Power (Hu): | 127.6 | kW |
| Feed water (47): | Mass flow: | 9.4 | kg/h |
| | Pressure: | 3 | bar (a) |
| | Temperature: | 100° | C. |
| Steam (89): | Mass flow: | 9.4 | kg/h |
| | Pressure: | 3 | bar (a) |
| | Saturated steam | | |

The steam (90) generated in SOFC mode is to be stored in a Ruth accumulator (91). The Ruth accumulator has a usable volume of 1 m³ and at the beginning of storing the following condition:

| | | |
|---|---|---|
| Pressure: | 2 | bar (a) |
| Degree of fill with boiling water: | 70% | (volume) |
| Mass boiling water: | 659.8 | kg |
| Mass saturated steam: | 0.34 | kg |
| Total mass content: | 660.14 | kg |

The store is charged up to a pressure of 10 bar(a) with saturated steam, and then has the following condition:

| | | |
|---|---|---|
| Pressure: | 10 | bar (a) |
| Degree of fill with boiling water: | 83.9% | (volume) |
| Mass boiling water: | 744.4 | kg |
| Mass saturated steam: | 0.83 | kg |
| Total mass content: | 745.23 | kg |

It means, in the vessel with 1 m³ effective volume, with a beginning degree of filling of 70% 85.1 kg steam are stored, which corresponds to a charging time, when the amount of steam (90) as specified is 20.2 kg/h, of about 4.2 hours (about 252 min).

The stored amount of steam of 85.1 kg is sufficient in the SOEC mode, based on a required steam output of −33.4 kg/h, for 2.5 hours (about 152.9 min).

As H₂-accumulator a gas pressure accumulator is assumed to have a volume of 5 m³. The lower pressure is due to the system pressure of the rSOC and should be, taking into consideration pressure losses, at 2 bar(a).

The boost pressure results from the H₂ amount to be stored in the SOEC mode of 9.81 kg (3.85 kg/h in 152.9 min) and corresponds at 25 C in case 1 to about 25.8 bar(a).

For the production of 85.1 kg of steam in the SOFC mode but 13.4 kg of hydrogen are needed, I.e. there is a hydrogen deficit of 3.6 kg which has to be met in this case by an external supply.

Case 1:

TABLE 1

| | m_{D} | m_{H2} | τ | m_{D} | m_{H2} | Δm_{D} | Δm_{H2} | Δτ |
|---|---|---|---|---|---|---|---|---|
| | kg/h | kg/h | min | kg | kg | kg | kg | min |
| SOFC | 20.23 | −3.19 | 252.40 | 85.10 | 13.42 | 0.00 | −3.61 | 67.89 |
| SOEC | −33.40 | 3.85 | 152.87 | −85.10 | 9.8 | | | |

Case 2:

The SOEC mode could also be operated longer (209.1 min), so that the hydrogen demand of 13.4 kg for the subsequent SOFC operation is ensured. In this case, the charge pressure in the pressure gas accumulator increases to 34.6 bar(a). However, then the amount of steam stored in the Ruth accumulator is no longer sufficient to produce the hydrogen. For this, 31.3 kg steam must be provided by an external supply.

TABLE 2

| | m_{D} | m_{H2} | τ | m_{D} | m_{H2} | Δm_{D} | Δm_{H2} | Δτ |
|---|---|---|---|---|---|---|---|---|
| | kg/h | kg/h | min | kg | kg | kg | kg | min |
| SOFC | 20.2 | −3.19 | 252.40 | 85.10 | −13.42 | | | |
| SOEC | −33.40 | 3.85 | 209.13 | −116.42 | 13.42 | −31.32 | 0.00 | 56.26 |

LIST OF REFERENCE NUMBERS

| | |
|---|---|
| 1 | steam |
| 1a | hydrogen |
| 2 | recirculated hydrogen |
| 3 | recuperative heat exchanger |
| 4 | hot hydrogen-steam mixture |
| 5 | electrolytic cell |
| 5a | fuel cell |
| 6 | electric heater |
| 7 | electricity |
| 8 | hot steam-hydrogen mixture |
| 9 | air |
| 10 | blower |
| 11 | recuperative heat exchanger |
| 12 | hot air-oxygen mixture |
| 12a | hot air-nitrogen mixture |
| 13 | electric heater |
| 14 | electric power |
| 15 | hot air |
| 16 | electric power |
| 17 | cooled hydrogen-steam mixture |
| 18 | heat exchanger |
| 19 | heat consumer |
| 20 | further cooled hydrogen-steam mixture |
| 21 | cooler |
| 22 | phase separator |
| 23 | condensate |
| 24 | hydrogen |
| 25 | hydrogen |
| 26 | blower |
| 27 | hydrogen |
| 28 | hydrogen for external consumer |
| 29 | hydrogen partial flow for storing |
| 30 | compressor |
| 31 | hydrogen-pressure accumulator |
| 32 | hydrogen for consumers |
| 33 | pressure control/throttle valve |
| 34 | air-oxygen mixture |
| 34a | air nitrogen mixture |
| 35 | heat exchanger |
| 36 | exhaust |
| 37 | heat consumer |
| 38 | external pressure steam/extrinsic steam |
| 39 | external steam |
| 40 | heat storage/Ruth accumulator |
| 41 | valve/valve |
| 42 | remaining external extrinsic steam |
| 43 | throttling/regulating valve |
| 44 | pressure measurement |
| 45 | throttling/regulating valve |
| 46 | required differential steam |
| 47 | feedwater |
| 48 | feedwater |
| 49 | internally generated steam |
| 50 | internally generated steam |
| 51 | feedwater |
| 52 | control valve |
| 53 | steam generator |
| 54 | low-temperature heat source |
| 55 | compressor/suction blower |
| 56 | pressure measurement |
| 57 | low pressure steam |
| 58 | SOEC |
| 58 | compressor/suction blower |
| 59 | compressur/suction fan |
| 60 | compressor/suction fan |
| 61 | hydrogen |
| 62 | air-O₂ mixture |
| 63 | control/throttle valve |
| 64 | heat pump |
| 65 | evaporator |
| 66 | condenser |
| 67 | compressor |
| 68 | throttle valve |
| 69 | gas distributor elements |
| 70 | water |
| 71 | three-way valve/control valve |
| 72 | three-way valve/control valve |
| 73 | temperature measurement |
| 74 | temperature measurement |
| 75 | bypass flow hydrogen |
| 76 | bypass air stream |
| 77 | hydrogen |
| 78 | three-way valve |
| 79 | gas separation |
| 80 | hydrogen |
| 81 | steam/hydrogen-steam |
| 82 | compressor |
| 83 | gas storage |
| 84 | pressure measurement |
| 85 | throttling/control valve |
| 86 | control valve |
| 87 | steam/hydrogen-steam |
| 88 | steam for extenal consumers |
| 89 | steam |
| 90 | steam |
| 91 | Ruth accumulator |
| 92 | steam |
| 93 | thottle valve |
| A | internal steam production via heat |
| | exchanger 35 |
| B | internal steam production via heat |
| | exchanger 18 |

1. A heat management method in a high-temperature steam electrolysis [SOEC] (FIG. 1), solid oxide fuel cell [SOFC] (FIG. 2) and/or reversible high-temperature fuel cell having SOEC and SOFC [rSOC] operating modes (FIG. 1/2), wherein required steam (1) is supplied from at least one external source, and at least one exhaust gas stream (4, 12, 12a) is cooled at least once (3, 11, 18, 35) after the cell [SOEC, SOFC, rSOC] (5, 5a)
wherein
an internal generation of required steam (1, 8) takes place by internal recuperative heating of externally supplied water (47, 48, 51), for which purpose the energy from the at least one cooling system (3, 11, 18, 35) of at least one exhaust gas stream to be cooled (4, 4a, 12, 12a, 17, 20, 34, 36) is used, and thereby the external steam supply (1, 38) is switched off or reduced.

2. The heat management method according to claim 1,
wherein
the internally recuperatively produced steam (1, 49, 50) is stored, and time-delayed is used again in the SOEC or process mode SOEC (5) of the rSOC.

3. The heat management method according to claim 1,
wherein
the steam generated internally recuperatively (1, 49, 50) is supplied directly in the SOEC or the rSOC in SOEC process mode (5).

4. The heat management method according to claim 1,
wherein
heat from an air-oxygen exhaust-gas stream (12, 34, 36) and/or from a hydrogen and/or steam-gas stream (4, 4a, 17, 20) is used recuperatively for steam production (49, 50).

5. The heat management method according to claim 1,
wherein
heat sources with temperatures below 100° C. (54) are used for the internal steam production (1, 57), wherein evaporation of water is carried out at low pressure (56), in particular below 1 bar, and wherein
the pressure of the steam produced (57) is subsequently boosted (55) to the operating pressure of the electrolysis
or
electrolysis occurs at low pressures (56), in particular below 1 bar, whereby the electrolysis products formed (61, 62), at least hydrogen (61), is subject to a pressure boost (59, 60) before further processing.

6. The heat management method according to claim 1,
wherein
heat sources with temperatures below 100° C. (54) are used internally for steam production (1, 57), wherein the temperature level of the heat source (54) is raised by means of a heat pump process (64) to a level useable for generating steam for the electrolysis.

7. The heat management method according to claim 1,
wherein
heat sources with temperatures below 100° C. (54) are used internally for steam production (1), wherein an internal recirculation of the products after the cell (5) are used as the carrier gas for the steam production.

8. The heat management method according to claim 1,
wherein
an additional recuperative heating of air (9) and/or hydrogen (1a, 2) is carried out with larger dimensioned recuperators (3, 11), wherein a bypass flow of the air (76) and/or the hydrogen (75) is guided temperature-controlled (73, 74) around the larger dimensioned recuperators (3, 11).

9. A high-temperature steam electrolysis [SOEC], solid oxide fuel cell [SOFC] and/or reversible high-temperature fuel cell having the operating modes SOEC and SOFC [rSOC] arrangement with a method according to claim 1, respectively comprising:
electrolysis/fuel cell (5, 5a),
two gas supply lines (8, 15),
two gas discharge lines (4, 12/12a)
wherein
at least a water evaporation means (53), a steam generator and/or heat exchanger (3,11, 18, 35) for generation of steam is provided in at least one gas discharge pipe (4, 12, 12a) for production of steam (1, 8, 49, 50, 57).

10. SOEC, SOFC and/or rSOC, according to claim 9,
wherein
the water evaporation means (18, 35, 53, 70), the steam generator and/or the heat exchanger for steam generation is provided in at least one gas discharge pipe (4, 12, 12a) downstream of a recuperative preheater (3, 11) for preheating gas (8, 15) to be supplied to the electrolysis/fuel cell (5, 5a).

11. SOEC, SOFC and/or rSOC according to claim 9,
wherein
a heat storage, a Ruth accumulator (40, 91), a gas pressure accumulator with an upstream compressor (83), a high-temperature storage, a latent heat accumulator and/or a thermo-chemical heat accumulator is provided for the storage of steam generated (1, 39, 49, 50, 57).

12. SOEC, SOFC and/or rSOC according to claim 9,
wherein
a water evaporation means (53, 70) is provided with a supply of heat with low temperature (54) from the SOEC, SOFC and/or rSOC, wherein the pressure (56) of the therein occurring steam generation is at an under 1 bar,
and wherein
after the water evaporation means (53), a compressor (55) is provided, which increases the pressure of steam generated (57) to process pressure or
the pressure in the subsequent electrolysis cell [SOEC] (5) in which the produced steam (57) is to be used, is under 1 bar, and after the electrolysis cell [SOEC] (5) at least one compressor (59, 60) is provided that increases the pressure of the obtained electrolysis gas or gases (61, 62) to at least ambient pressure.

13. SOEC, SOFC and/or rSOC according to claim 9,
wherein
a heat pump assembly (64) is provided, which with use of energy brings the low-temperature heat with T<100° C. (54) to a higher temperature level to be used as heat for a water evaporation (53, 1) at the process pressure of SOEC or the rSOC.

14. SOEC, SOFC and/or rSOC according to claim 9,
wherein
a hydrogen storage (31, 83), gas pressure accumulator to the internal storage of hydrogen (29, 77, 81, 87, 1a) and/or steam is provided.

15. SOEC, SOFC and/or rSOC according to claim 9,
wherein
the plant is part of a carbohydrate synthesis plant, particularly one involving regeneratively generated electric energy in the synthesis process, wherein the external steam (1, 38) is mainly derived from the carbohydrate synthesis plant.

16. The heat management method according to claim 1, wherein the internally recuperatively produced steam (1, 49, 50) is stored in a Ruth accumulator (40, 91) and time-delayed is used again in the SOEC or process mode SOEC (5) of the rSOC.

17. The heat management method according to claim 1, wherein heat sources with temperatures below 100° C. (54) are used internally for steam production (1), wherein an internal recirculation of hydrogen (2, 4, 87) after the cell (5) is used as the carrier gas for the steam production.
